(19) United States
(12) Patent Application Publication
(10) Pub. No.: US 2026/0098931 A1
(43) Pub. Date: Apr. 9, 2026

(54) SYSTEMS AND METHODS FOR REDUCED ENERGY RANDOMIZED LOCATION DETECTION

(71) Applicant: Copeland Cold Chain LP, Kennesaw, GA (US)

(72) Inventors: Justin T. Hall, Webb City, MO (US); Rodney Parsons, Jupiter, FL (US)

(21) Appl. No.: 18/910,436

(22) Filed: Oct. 9, 2024

(51) Int. Cl. G01S 5/14; G01S 5/02

(52) U.S. Cl. CPC G01S 5/145; G01S 5/02213

(57) ABSTRACT

A system for determining a device location includes a computer device including at least one processor in communication with at least one memory device, wherein the at least one processor programmed to: a) receive a plurality of wireless signals from a plurality of sources; b) determine a signal strength for each wireless signal of the plurality of wireless signals; c) select one or more wireless signals of the plurality of wireless signals based upon a comparison of signal strengths; d) randomly select one or more additional wireless signals of the remaining plurality of wireless signals; and e) determine a location of the computer device based upon the one or more wireless signals and the one or more additional wireless signals.

### FIELD

The present disclosure relates to reduced energy randomized location detection, and, more particularly, to a network-based system and method for analyzing signals from randomized wireless access points to determine a location.

### BACKGROUND

Many systems exist for determining the location of device or object, such as GPS (global positioning systems), including situation where the object is in transit or the device is tracking a device in transit. However these require significant amounts of power to operate, especially for mobile devices. Furthermore, GPS systems do not work in certain conditions, such as in buildings or very urban areas. Cellular triangulation exists, but is not very accurate. Additionally, Wi-Fi may be used for providing locations in areas where GPS fails, while using less battery power. However, while GPS may be used as a stand-alone product, Wi-Fi location systems currently require databases with listings of Wi-Fi devices and their locations. Furthermore, many devices may not be in the database, either for not being added yet or because the device is a mobile device, such as a hot spot provided by a mobile phone or a vehicle. To correct for these issues, many existing systems require more information about nearby devices, which can increase packet size by requiring larger messages or increased battery usage from longer scan times.

This background section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, these statements are to be read in this light, and not as admissions of prior art.

### BRIEF SUMMARY

The present embodiments may relate to systems and methods for analyzing signals from randomized wireless access points to determine a location. The platform may include a location detection (“LD”) computer system and/or a plurality of user computer devices.

In one aspect, a location detection (“LD”) system for analyzing signals from randomized wireless access points to determine a location is disclosed. The LD system includes at least one computer device including at least one processor in communication with at least one memory device. The at least one processor is programmed to a) receive a plurality of wireless signals from a plurality of sources; b) determine a signal strength for each wireless signal of the plurality of wireless signals; c) select one or more wireless signals of the plurality of wireless signals based upon a comparison of signal strengths; d) randomly select one or more additional wireless signals of the remaining plurality of wireless signals; and e) determine a location of the computer device based upon the one or more wireless signals and the one or more additional wireless signals. The system may have additional, less, or alternate functionalities, including those discussed elsewhere herein.

In another aspect, a computer-based method for analyzing signals from randomized wireless access points to determine a location is disclosed. The method is implemented on a location detection (“LD”) computer device including at least one processor in communication with at least one memory device. The method includes a) receiving a plurality of wireless signals from a plurality of sources; b) determining a signal strength for each wireless signal of the plurality of wireless signals; c) selecting one or more wireless signals of the plurality of wireless signals based upon a comparison of signal strengths; d) randomly selecting one or more additional wireless signals of the remaining plurality of wireless signals; and e) determining a location of the computer device based upon the one or more wireless signals and the one or more additional wireless signals. The method may have additional, less, or alternate functionalities, including those discussed elsewhere herein.

In yet another aspect, at least one non-transitory computer-readable storage media having computer-executable instructions embodied thereon is disclosed. When executed by at least one processor, the computer-executable instructions may cause the processor to receive a plurality of indicators of compromise associated with active threat actors. The computer-executable instructions may also cause the processor to generate a plurality of validation tests to test for the plurality of indicators of compromise. The computer-executable instructions may further cause the processor to a) receive a plurality of wireless signals from a plurality of sources; b) determine a signal strength for each wireless signal of the plurality of wireless signals; c) select one or more wireless signals of the plurality of wireless signals based upon a comparison of signal strengths; d) randomly select one or more additional wireless signals of the remaining plurality of wireless signals; and e) determine a location of the computer device based upon the one or more wireless signals and the one or more additional wireless signals. The computer-readable storage media may have additional, less, or alternate functionalities, including those discussed elsewhere herein.

Advantages will become more apparent to those skilled in the art from the following description of the embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals. There are shown in the drawings arrangements which are presently discussed, it being understood, however, that the present embodiments are not limited to the precise arrangements and are instrumentalities shown.

FIG. 1 illustrates a block diagram of a system for analyzing signals from randomized wireless access points to determine a location, in accordance with at least one embodiment of the disclosure.

FIG. 2 illustrates a block diagram of a process for collecting and analyzing signals from randomized wireless access points to determine a location using the system shown in FIG. 1.

FIG. 3 illustrates a block diagram of a process for analyzing signals from randomized wireless access points to determine a location using the system shown in FIG. 1.

FIG. 4 illustrates a simplified block diagram of an example computer system for implementing the processes shown in FIGS. 2 and 3.

FIG. 5 illustrates an example configuration of a client computer device, in accordance with one embodiment of the present disclosure.

FIG. 6 illustrates an example configuration of a server system, in accordance with one embodiment of the present disclosure.

Corresponding reference characters indicate corresponding parts throughout the drawings.

### DETAILED DESCRIPTION

The present embodiments may relate to, inter alia, systems and methods for analyzing signals from randomized wireless access points to determine a location. In one example embodiment, the methods may be performed by a location detection(“LD”) computer device, also known as a location detection(“LD”) server.

At least one of the technical solutions to the technical problems provided by this system may include: (i) improving speed and accuracy of location detection; (ii) decreased number of Wi-Fi access points needed to estimate location; (iii) decreased required message traffic needed for determining location; (iv) decreased battery usage required; and (v) decreased processing needed.

The methods and systems described herein may be implemented using computer programming or engineering techniques including computer software, firmware, hardware, or any combination or subset thereof, wherein the technical effects may be achieved by performing at least one of the following steps: a) receive a plurality of wireless signals from a plurality of sources; b) determine a signal strength for each wireless signal of the plurality of wireless signals; c) select one or more wireless signals of the plurality of wireless signals based upon a comparison of signal strengths; d) randomly select one or more additional wireless signals of the remaining plurality of wireless signals; e) determine a location of the computer device based upon the one or more wireless signals and the one or more additional wireless signals; f) wherein the wireless signals are Wi-Fi signals; g) wherein the plurality of sources are access points; h) select a predetermined number of wireless signals with the strongest signal strengths; i) wherein the one or more additional wireless signals include a number of wireless signals greater than or equal to the one or more wireless signals; j) wherein each wireless signal of the plurality of wireless signals includes identifying information; k) transmit, to a remote server, the identifying information for the one or more wireless signals and the one or more additional wireless signals; l) receive, from the remote server, the location of the computer device; m) wherein the identifying information includes a MAC address for the source of the wireless signal and a signal strength of the wireless signal; n) scan for the plurality of wireless signals; o) turn off Wi-Fi detection when a battery charge is below a predetermined threshold; and/or p) determine the location of the computer device by looking up the one or more wireless signals and the one or more additional wireless signals in the database of known wireless sources.

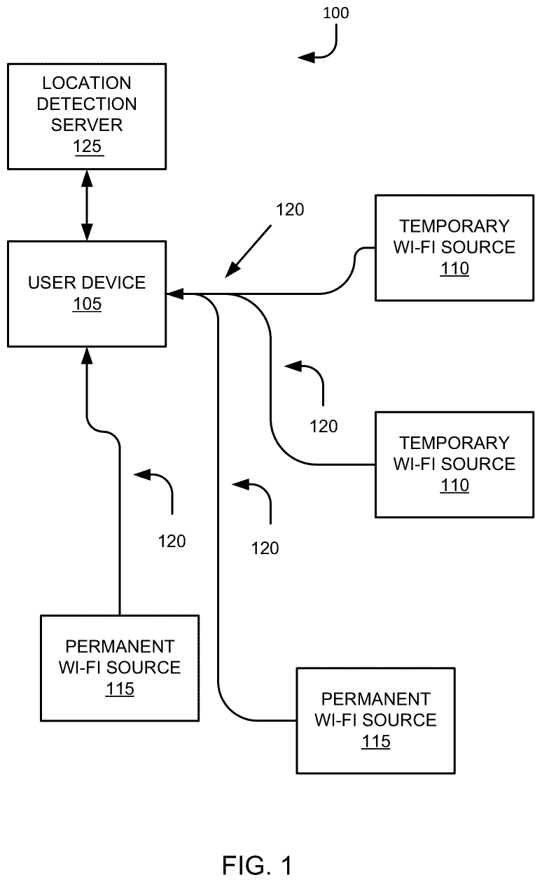

FIG. 1 illustrates a simplified block diagram of a system 100 for analyzing signals from randomized wireless access points to determine a location, in accordance with at least one embodiment of the disclosure.

In the example embodiment, a user device 105 is attempting to determine its location. The user device 105 is in a location in range of one or more access points or other wireless signal sources. In this case, the user device 105 is in range of two temporary Wi-Fi sources 110 and two permanent Wi-Fi sources 115. The temporary Wi-Fi sources 110 are devices that temporarily produce wireless signals, such as a phone, vehicle, or other device that is providing a mobile hotspot. The permanent Wi-Fi sources 115 are stationary transmitters that provide wireless signals, such as a Wi-Fi access point that a user may use to access one or more wireless networks.

The user device 105 receives signals 120 from the temporary Wi-Fi sources 110 and the permanent Wi-Fi sources 115. The different signals 120 may have different signal strengths, such as due to the distance between the user device 105 and the corresponding source 110 and 115. Obstructions and other signals 120 may also affect the corresponding strengths of the signals 120 received by the user device 105. To determine the strength of each signal 120, the user device 105 measures the RSSI (received signal strength indicator) for each received signal. In other embodiments, the user device 105 measures the signal strength in dBM (decibels milliwatts). Either measurement may then be used by the user device 105 to determine relative strengths of the received signals 120.

The received signals 120 of this embodiment include identifying information about the source 110 or 115. The identifying information may include, but is not limited to, the MAC address (media access control address) for the source 110 or 115, SSID (service set identifier), IP (Internet protocol) address, and/or any other device identifier that allows the system 100 to work as described herein.

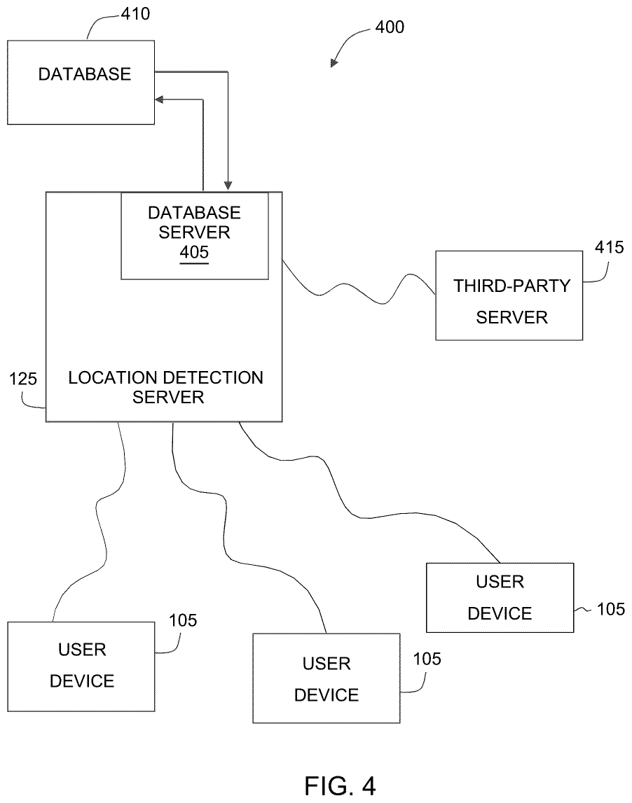

The example user device 105 determines the identifying information for one or more of the sources 110 or 115 to the location detection (LD) server 125. The LD server 125 queries one or more databases 410 (shown in FIG. 4) with the identifying information to determine a location associated with the corresponding sources 110 or 115. In the example embodiment, the one or more databases 410 allow a user to look-up locations associated with different permanent wireless sources 115 using the identifying information. The one or databases 410 include the geolocation information for the corresponding devices. In some embodiments, the location includes latitude and longitude. In other embodiments, the location includes other geolocation information as desired. Then the LD server 125 returns the determined location to the user device 105.

The user device 105 provides the identifying information of one or more temporary Wi-Fi sources 110 or one of more permanent Wi-Fi sources 115 that are not in the databases 410. In these situations, the LD server 125 drops those sources 110 and 115 that are not in the queried database(s) 410. For example, if the LD server 125 receives identifying information for three sources 110 or 115 and two of those sources 110 or 115 are not in the databases 410, then the LD server 125 returns the location based on the remaining source 115. If none of the sources 110 or 115 are in the database(s) 410, then the LD server 125 may request additional identifying information from other sources 110 or 115 whose signals 120 were detected by the user device 105. This may require identifying information from larger numbers of sources 110 and 115 to ensure that location information may be found. This could potentially increase the number of sources 110 or 115 needed, which could then increase required scan time, message traffic, and processing time to determine the location of the user device 105.

The example user device 105 selects one or more signals 120 with the highest strength and one or more signals 120 randomly from the rest of the signals received to transmit to the LD server 125. This drastically increases the possibility that the LD server 125 with find one or more of the provided sources 110 or 115 in the database(s) 410. In at least one embodiment, at least 50% of the signals 120 selected by the user device 105 are selected randomly, with the remaining signals 120 being chosen for having the highest relative signal strength. If a source 110 or 115 with identifying information is not in the databases 410, then the LD server 125 returns an error. By randomizing some of the sources 110 and 115 that are used to provide identifying information, the system 100 can ensure that high signal strength sources from temporary Wi-Fi sources 110 or permanent Wi-Fi sources 115 not in the database 410, do not repeatedly get sent to the LD server 125 or repeatedly checked.

For the purposes of the following examples, the identifying information is the MAC address and the sources 110 and 115 are access points. In these examples, the user device 105 detects nine signals 120 from nine different sources 110 or 115.

In the first example, the user device 105 transmits five MAC addresses to the LD server 125. The user device 105 selects the MAC addresses for the two signals 120 with the highest RSSI. Then the user device 105 selects three of the remaining seven signals 120 at random and transmits their corresponding MAC addresses.

In a second example, the user device 105 transmits three MAC addresses to the LD server 125. The user device 105 selects the MAC address for the signal 120 with the highest RSSI. Then the user device 105 selects two of the remaining eight signals 120 at random and transmits their corresponding MAC addresses.

In a third example, the user device 105 transmits two MAC addresses to the LD server 125. The user device 105 selects the MAC addresses for the signal 120 with the highest RSSI. Then the user device 105 selects one of the remaining eight signals 120 at random and transmits its corresponding MAC address.

In the example embodiment, the user device 105 transmits the MAC address and the RSSI value for each signal 120 to the LD server 125. In other embodiments, the user device 105 just transmits the MAC addresses.

The user device 105 is suitably integrated with the LD server 125 and queries the databases 410 itself to determine its location. While the above system 100 describes using Wi-Fi access points 110 and 115, one having skill in the art would understand that the systems and methods described herein may also be used with other wireless protocols, including, but not limited to, Bluetooth, Near Field Communication, LoRa (long range), and Zigbee protocols.

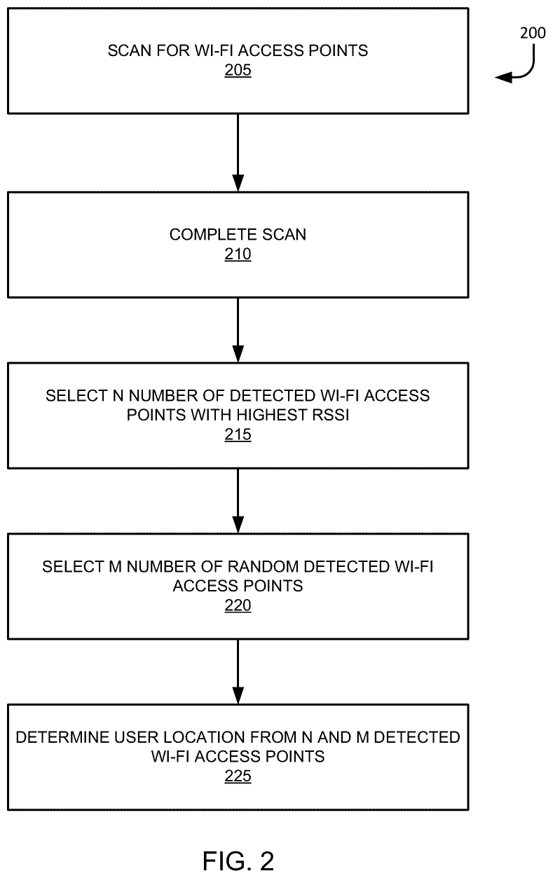

FIG. 2 illustrates a block diagram of a process 200 for collecting and analyzing signals from randomized wireless access points to determine a location using the system 100 (shown in FIG. 1). In the example embodiment, the steps of process 200 are performed by the user device 105 (shown in FIG. 1). In the example embodiment, the user device 105 is in range of one or more Wi-Fi sources 110 and 115 (both shown in FIG. 1).

The example user device 105 scans 205 for Wi-Fi access points, such as sources 110 and 115 (shown in FIG. 1). The user device 105 receives signals 120 (shown in FIG. 1) from the Wi-Fi access points in range. Then the user device 105 completes 210 the scan. In some embodiments, the user device 105 performs the scan 205 in a short amount of time to preserve battery life. For example, the user device 105 may perform the scan 205 in 1.4 seconds, such as by scanning channels 1-14 for 100 ms each. In some further embodiments, the user device 105 shuts down its Wi-Fi receiver when the charge in the battery is below a predetermined or user set threshold.

The user device 105 suitably selects 215 N number of detected Wi-Fi access points with the highest RSSI values. The user device 105 determines the RSSI values, or other signal strength measurement, for all of the signals 120 received from the sources 110 and 115. Then the user device 105 selects 215 one or more of the signals 120 with the highest RSSI values.

The user device 105 also may select 220 M number of random detected Wi-Fi access points. The user device 105 may select 220 randomly from the remaining list of Wi-Fi access points whose signals 120 were detected by the user device 105 during the scan 205. These Wi-Fi access points are selected independently of their RSSI values.

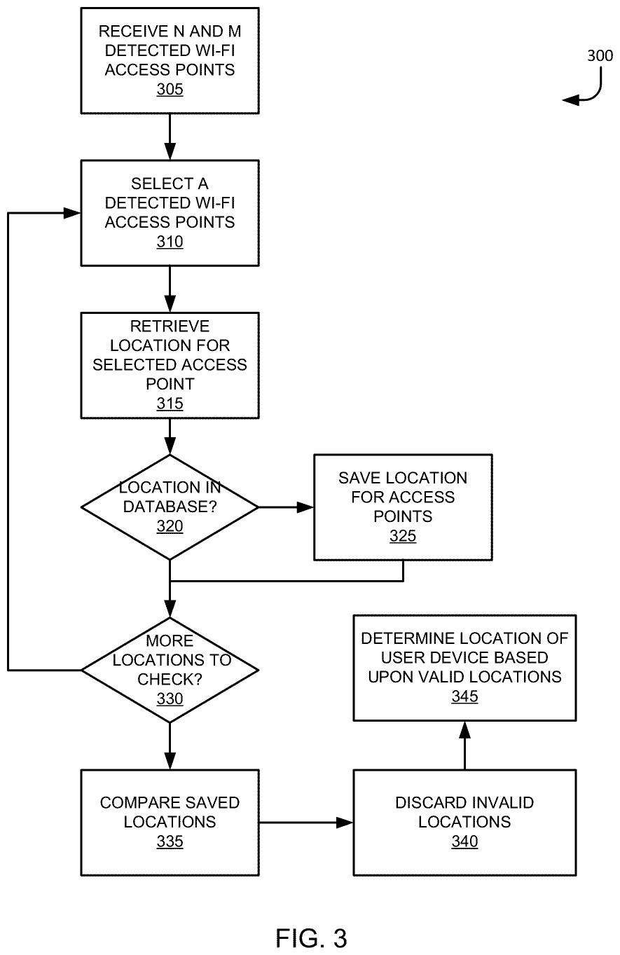

The example user device 105 determines 225 the user location from the N and M detected Wi-Fi access points. In the example embodiment, the user device 105 transmits the identification information (MAC address and RSSI values) for the N and M detected Wi-Fi access points to the LD server 125 (shown in FIG. 1), which determines 225 the location of the user device 105 from that information, such as by performing the steps of process 300 (shown in FIG. 3). In other embodiments, the user device 105 determines 225 its location by performing the steps of process 300.

FIG. 3 illustrates a block diagram of a process 300 for analyzing signals from randomized wireless access points to determine a location using the system 100 (shown in FIG. 1). In the example embodiment, the steps of process 300 are performed by the LD server 125 (shown in FIG. 1). In other embodiments, the steps of process 300 are performed by the user device 105 (shown in FIG. 1).

The example LD server 125 receives 305 N and M detected Wi-Fi access points, such as sources 110 and 115 (both shown in FIG. 1). N detected Wi-Fi access points are signals 120 (shown in FIG. 1) received by the user device 105 with the highest RSSI or other signal strength values. M detected Wi-Fi access points are randomly selected from the rest of the signals 120 not included in the N detected Wi-Fi access points. For each of the N and M detected Wi-Fi access points, the LD server 125 receives 305 identifying information, such as, but not limited to, the MAC address of the device transmitting the received signal 120, and the signal strength, such as the RSSI value of the received signal 120.

The LD server 125 also may select 310 a detected Wi-Fi access point, from the N and M detected Wi-Fi access points. For that selected access point, the LD server 125 retrieves 315 the location corresponding to the selected access point from the database 410 (shown in FIG. 4). The LD server 125 determines 320 if the location is in the database 410. If the location is in the database 410, the LD server 125 saves 325 the location for the access point. The location database 410 includes a plurality locations for a plurality of access points and/or other devices that may transmit a wireless signal 120 that the user device 105 receives or detects. The LD server 125 queries 315 the database 410 with the identification information and receives the location of the corresponding device if that device is in the database 410. Temporary Wi-Fi sources 110 (shown in FIG. 1) are not found in the database 410.

The LD server 125 determines 330 if there are more locations to check. If there are more locations to check, the LD server 125 returns to step 310 and repeats the loop for all of the access points in the N and M detected Wi-Fi access points. If there are no more locations to check, the LD server 125 compares 335 the saved locations to each other. The LD server 125 determines if the saved locations are valid based upon the comparison. The LD server 125 compares 335 the saved locations to make sure that they are all in the same area. For example, a temporary Wi-Fi source 110 may have the same MAC address as a known permanent Wi-Fi source 115 that is stored in the database 410. So if two locations come back as being in an area of St. Louis and one location comes back as being in part of New York City, the LD server 125 determines that the New York City location is invalid. The LD server 125 may also look at the previous location determinations for the user device 105 to see if the current locations make since. For example, if the previous location was Chicago, and the current location, ten minutes later is San Francisco, the LD server 125 may determine that one or more of the locations are invalid. The LD server 125 discards 340 the invalid locations. Then the LD server 125 determines 345 the location of the user device 105 based upon the remaining valid locations. The LD server 125 returns the location to the user device 105. The user device 105 suitably has access to the one or more databases 410 and is able to perform the steps of process 300.

In some embodiments, the user device 105 may be in transit, travelling from one location to another. In another embodiment, the user device 105 is tracking cargo while the cargo is travelling from one location to another, aka between a first location and a second location.

FIG. 4 illustrates a simplified block diagram of an example system 400 for implementing the processes 200 and 300 (shown in FIGS. 2 and 3). System 400 may be used for location detection of computer systems. As described below in more detail, a location detection (“LD”) computer system, also known as location detection (“LD”) server 125, may be configured to a) receive a plurality of wireless signals 120 (shown in FIG. 1) from a plurality of sources 110 and 115 (both shown in FIG. 1); b) determine a signal strength for each wireless signal 120 of the plurality of wireless signals 120; c) select one or more wireless signals 120 of the plurality of wireless signals 120 based upon a comparison of signal strengths; d) randomly select one or more additional wireless signals 120 of the remaining plurality of wireless signals 120; and e) determine a location of the computer device 105 based upon the one or more wireless signals 120 and the one or more additional wireless signals 120.

User devices 105 may be computers that include a web browser or a software application, which enables user devices 105 to access remote computer devices, such as the LD server 125, using the Internet or other network. More specifically, user devices 105 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User devices 105 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

A database server 405 may be communicatively coupled to a database 410 that stores data. In one embodiment, database 410 may include location information, MAC addresses, location coordinates, and previous requests. In the example embodiment, database 410 may be stored remotely from LD server 125. In some embodiments, database 410 may be decentralized. In the example embodiment, a user may access database 410 via user device 105 by logging onto the LD server 125, as described herein.

The LD server 125 may be in communication with a plurality of user devices 105 to receive access point identifiers and to transmit location information to at least one of the plurality of user devices 105. In some embodiments, the LD server 125 may host or include artificial intelligence functionality, where the artificial intelligence performs the steps of either process 200 and/or process 300. In some embodiments, LD server 125 may be a plurality of computer devices working in concert to perform the steps outlined herein. Third-party servers 415 are suitably websites, servers, systems, and services that describe location information and/or may contain location data for sources.

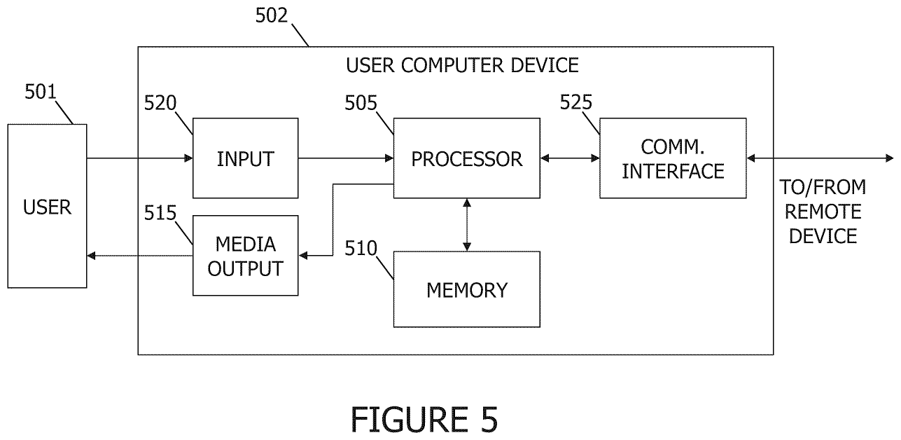

FIG. 5 depicts an example configuration of a client computer device, in accordance with one embodiment of the present disclosure. User computer device 502 may be operated by a user 501. User computer device 502 may include, but is not limited to, user device 105, temporary access points 110, and permanent access points 115 (all shown in FIG. 1). User computer device 502 may include a processor 505 for executing instructions. In some embodiments, executable instructions may be stored in a memory area 510. Processor 505 may include one or more processing units (e.g., in a multi-core configuration). Memory area 510 may be any device allowing information such as executable instructions and/or transaction data to be stored and retrieved. Memory area 510 may include one or more computer readable media.

User computer device 502 may also include at least one media output component 515 for presenting information to user 501. Media output component 515 may be any component capable of conveying information to user 501. In some embodiments, media output component 515 may include an output adapter (not shown) such as a video adapter and/or an audio adapter. An output adapter may be operatively coupled to processor 505 and operatively coupleable to an output device such as a display device (e.g., a cathode ray tube (CRT), liquid crystal display (LCD), light emitting diode (LED) display, or “electronic ink” display) or an audio output device (e.g., a speaker or headphones).

Media output component 515 may be configured to present a graphical user interface (e.g., a web browser and/or a client application) to user 501. A graphical user interface may include, for example, an interface for viewing location information. In some embodiments, user computer device 502 may include an input device 520 for receiving input from user 501. User 501 may use input device 520 to, without limitation, to provide location information.

Input device 520 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 515 and input device 520.

User computer device 502 may also include a communication interface 525, communicatively coupled to a remote device such as LD server 125 (shown in FIG. 1). Communication interface 525 may include, for example, a wired or wireless network adapter and/or a wireless data transceiver for use with a mobile telecommunications network.

Stored in memory area 510 are, for example, computer readable instructions for providing a user interface to user 501 via media output component 515 and, optionally, receiving and processing input from input device 520. A user interface may include, among other possibilities, a web browser and/or a client application. Web browsers enable users, such as user 501, to display and interact with media and other information typically embedded on a web page or a website from LD server 125. A client application may allow user 501 to interact with, for example, LD server 125. For example, instructions may be stored by a cloud service, and the output of the execution of the instructions sent to the media output component 515.

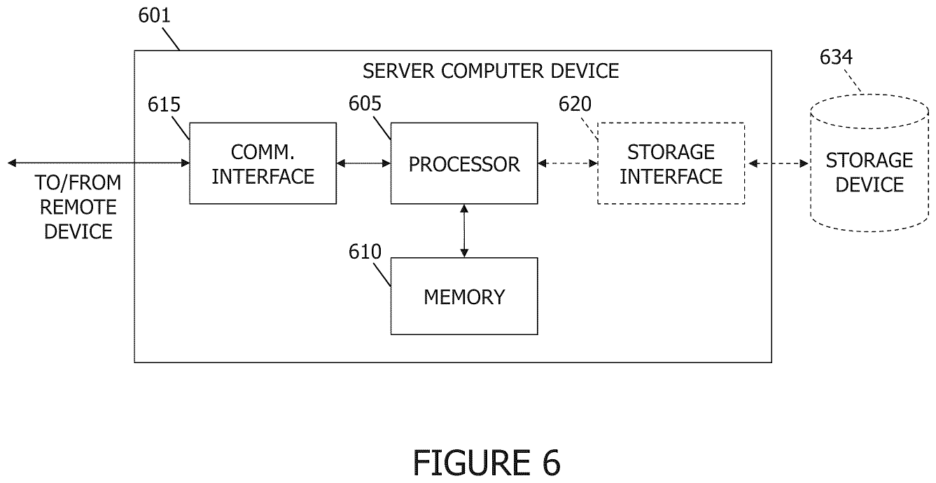

FIG. 6 depicts an example configuration of a server system, in accordance with one embodiment of the present disclosure. Server computer device 601 may include, but is not limited to, LD server 125, (shown in FIG. 1), third-party server 415, and database server 405 (shown in FIG. 4). Server computer device 601 may also include a processor 605 for executing instructions. Instructions may be stored in a memory area 610. Processor 605 may include one or more processing units (e.g., in a multi-core configuration).

Processor 605 may be operatively coupled to a communication interface 615 such that server computer device 601 is capable of communicating with a remote device such as another server computer device 601, LD server 125, third-party server 415, and user devices 105 (shown in FIG. 1) (e.g. using wireless communication or data transmission over one or more radio links or digital communication channels). For example, communication interface 615 may receive requests from user devices 105 via the Internet, as illustrated in FIG. 1.

Processor 605 may also be operatively coupled to a storage device 634. Storage device 634 may be any computer-operated hardware suitable for storing and/or retrieving data, such as, but not limited to, data associated with database 410 (shown in FIG. 4). In some embodiments, storage device 634 may be integrated in server computer device 601. For example, server computer device 601 may include one or more hard disk drives as storage device 634.

Storage device 634 may be external to server computer device 601 and may be accessed by a plurality of server computer devices 601. For example, storage device 634 may include a storage area network (SAN), a network attached storage (NAS) system, and/or multiple storage units such as hard disks and/or solid-state disks in a redundant array of inexpensive disks (RAID) configuration.

Processor 605 may be operatively coupled to storage device 634 via a storage interface 620. Storage interface 620 may be any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 634.

Processor 605 may execute computer-executable instructions for implementing aspects of the disclosure. In some embodiments, the processor 605 may be transformed into a special purpose microprocessor by executing computer-executable instructions or by otherwise being programmed. For example, the processor 605 may be programmed with the instruction such as illustrated in FIGS. 2 and 3.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS′ include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In another example, a computer program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

The computer-implemented methods discussed herein can include additional, less, or alternate actions, including those discussed elsewhere herein. The methods can be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein can include additional, less, or alternate functionality, including that discussed elsewhere herein. The computer systems discussed herein can include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein can be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for determining a device location comprising a computer device comprising at least one processor in communication with at least one memory device, wherein the at least one processor programmed to:
receive a plurality of wireless signals from a plurality of sources;
determine a signal strength for each wireless signal of the plurality of wireless signals;
select one or more wireless signals of the plurality of wireless signals based upon a comparison of signal strengths;
randomly select one or more additional wireless signals of the remaining plurality of wireless signals; and
determine a location of the computer device based upon the one or more wireless signals and the one or more additional wireless signals.

2. The system of claim 1, wherein the wireless signals are Wi-Fi signals.

3. The system of claim 2, wherein the plurality of sources are access points.

4. The system of claim 1, wherein the comparison of signal strengths further comprises select a predetermined number of wireless signals with the strongest signal strengths.

5. The system of claim 1, wherein the one or more additional wireless signals include a number of wireless signals greater than or equal to the one or more wireless signals.

6. The system of claim 1, wherein each wireless signal of the plurality of wireless signals includes identifying information.

7. The system of claim 6, wherein the at least one processor is further programmed to transmit, to a remote server, the identifying information for the one or more wireless signals and the one or more additional wireless signals.

8. The system of claim 7, wherein the at least one processor is further programmed to receive, from the remote server, the location of the computer device.

9. The system of claim 6, wherein the identifying information includes a MAC address for the source of the wireless signal and a signal strength of the wireless signal.

10. The system of claim 1, wherein the at least one processor is further programmed to scan for the plurality of wireless signals.

11. The system of claim 10, wherein the at least one processor is further programmed to turn off Wi-Fi detection when a battery charge is below a predetermined threshold.

12. The system of claim 1, wherein the computer device is in transit between a first location and a second location.

13. The system of claim 1, further comprising a database of known sources of wireless signals, and wherein the at least one processor is further programmed to determine the location of the computer device by looking up the one or more wireless signals and the one or more additional wireless signals in the database of known sources of wireless sources.

14. A method for determining a device location implemented on a computer device comprising at least one processor in communication with at least one memory device, wherein the method comprises:
receiving a plurality of wireless signals from a plurality of sources;
determining a signal strength for each wireless signal of the plurality of wireless signals;
selecting one or more wireless signals of the plurality of wireless signals based upon a comparison of signal strengths;
randomly selecting one or more additional wireless signals of the remaining plurality of wireless signals; and
determining a location of the computer device based upon the one or more wireless signals and the one or more additional wireless signals.

15. The method of claim 14, wherein the comparison of signal strengths further comprises selecting a predetermined number of wireless signals with the strongest signal strengths.

16. The method of claim 14, wherein the one or more additional wireless signals include a number of wireless signals greater than or equal to the one or more wireless signals, and where the method further comprises:
transmitting, to a remote server, the identifying information for the one or more wireless signals and the one or more additional wireless signals; and
receiving, from the remote server, the location of the computer device.

17. The method of claim 16, wherein the identifying information includes a MAC address for the source of the wireless signal and a signal strength of the wireless signal.

18. The method of claim 14, wherein the at least one processor is further programmed to scan for the plurality of wireless signals.

19. The method of claim 14 further comprising determining the location of the computer device by looking up the one or more wireless signals and the one or more additional wireless signals in a database of known wireless sources.

20. At least one non-transitory computer-readable storage media having computer-executable instructions embodied thereon, when executed by at least one processor, the computer-executable instructions may cause the processor to:
receive a plurality of wireless signals from a plurality of sources;
determine a signal strength for each wireless signal of the plurality of wireless signals;
select one or more wireless signals of the plurality of wireless signals based upon a comparison of signal strengths;
randomly select one or more additional wireless signals of the remaining plurality of wireless signals; and
determine a location of the processor based upon the one or more wireless signals and the one or more additional wireless signals.
